(19) United States
(12) Patent Application Publication
(10) Pub. No.: US 2024/0270766 A1
(43) Pub. Date: Aug. 15, 2024

(54) PHOSPHOLIPID PROCESSING AID AND APPLICATION THEREOF

(71) Applicants: SHANGHAI BOBEYMAN TECHNOLOGY CO. LTD, Shanghai (CN); SHANGHAI TAIWEI PHARMACEUTICAL CORP. LTD., Shanghai (CN)

(72) Inventor: Ziqian Xu, Inner Mongolia (CN)

(73) Assignees: SHANGHAI BOBEYMAN TECHNOLOGY CO. LTD, Shanghai (CN); SHANGHAI TAIWEI PHARMACEUTICAL CORP. LTD., Shanghai (CN)

(21) Appl. No.: 18/557,294

(22) PCT Filed: Jun. 17, 2021
(86) PCT No.: PCT/CN2021/100554

§ 371 Date: Mar. 22, 2024

(30) Foreign Application Priority Data
Apr. 27, 2021 (CN) 202110462040.8

(51) Int. Cl. C07F 9/10

(52) U.S. Cl. CPC C07F 9/103

(57) ABSTRACT

The invention relates to the field of phospholipid processing, in particular to a phospholipid processing aid and an application thereof. The phospholipid processing aid is a yellow brown powdery solid that is easily dissolved and ionized in water, yet insoluble in n-hexane. A preparation method for the phospholipid processing aid comprises: raw soybean oil sediments reacting with raw water, and settling to obtain a layered product wherein the second layer of product from bottom to top is an aqueous phase, and drying the aqueous phase to obtain the phospholipid processing aid.

### TECHNICAL FIELD

The invention relates to the field of phospholipid processing, in particular to a phospholipid processing aid and an application thereof.

### RELATED ART

The raw material for phospholipid processing is soybean oil sediments, shortly referred to as oil sediments. It is a by-product of the hydration degumming process during the soybean oil refining process in the field of oil processing. It is also called hydrated oil sediments. Its main components are phospholipids 30-45 g/100 g. soybean oil 20-30 g/100 g and moisture 30-50 g/100 g. The trace components are metal ions, including calcium, magnesium and iron, which exist in the form of phospholipid metal salts. The iron ion content, for example, is usually 50-100 mg/kg and up to 150 mg/kg in some cases, based on acetone insoluble matter.

There are two main industrialized phospholipid processing methods. One is the hydration method to prepare concentrated phospholipids, that is, after hydrating and extracting soybean oil sediment from soybean crude oil, it is directly dried and dehydrated to obtain concentrated phospholipids. Because of its fluidity, it is also called fluid phospholipids. Dry acetone insoluble content is 60-65 g/100 g for concentrated phospholipids. The second is to prepare powdered phospholipids by solvent method, that is, using soybean oil sediments or concentrated phospholipids as raw materials, extracting with acetone to remove the grease, and obtaining powdered phospholipids, whose dry acetone insoluble content is 95-98 g/100 g. At present, the mainstream products on the market are concentrated phospholipids, and powdered phospholipids account for less than 5% of the market.

Although most soybean oil sediments are processed into concentrated phospholipids, concentrated phospholipids have major shortcomings. For example, a method for producing concentrated phospholipids using hydrated oil sediments as raw materials followed by dehydration and oxidative bleaching was described by Hu X. and by Hu Q. et al., published in China Oils and Fats 2007,32(9):20-21 and in China Oils and Fats 2002, 27(1):39-40, respectively. The disadvantages of this process are that the acetone insoluble content of concentrated phospholipids is low (60-65 g/100 g), chemical bleaching is required, and the market price of concentrated phospholipids is significantly lower than the price of powdered phospholipids.

At present, there are many shortcomings in the research on preparing phospholipids by hydration method. For example, Chinese patent CN107325125A discloses a method for preparing hydrated phospholipids from soybean oil sediments and hydrated phospholipids obtained by the fore mentioned method (hereinafter referred to as hydrated phospholipids). The amount of water added in this patented method is 24-74% of the amount of soybean oil sediments and is obviously insufficient. The patent does not mention the fate of the inactivated phospholipids and water-soluble impurities derived from soybean oil sediments in the process, nor does it explain the n-hexane insoluble content index of the phospholipid products. Judging from the amount of water added and the process method of this patented method, it is difficult to separate the inactivated phospholipids and water-soluble impurities in the raw soybean oil sediments, and it is difficult to guarantee the surface activity and n-hexane insoluble content of the hydrated phospholipids.

Another existing hydration method for extraction of phospholipids from soybean oil sediments is described by Li Z. et al., published in Chinese Journal of Cereals and Oils, 2007, 22(1):31-32, in which the phospholipids product is called liquid crystalline phospholipids. The amount of water added in the abovementioned method is 60% of the amount of soybean oil sediments, which is obviously insufficient. The patent does not explain the fate of the inactivated phospholipids and water-soluble impurities in the raw material soybean oil sediments, nor does it explain the n-hexane insoluble matter index of the phospholipid products. Similarly, judging from the amount of water added and the process method of this method, it is difficult to separate the inactivated phospholipids and water-soluble impurities derived from soybean oil sediments. This method has the following technical flaws: first, the liquid crystal state of the phospholipid is not characterized in the literature, thus it cannot be determined whether it is a liquid crystal state or what kind of liquid crystal state it is; second, the acetone insoluble content of the phospholipid in the literature is only 86.05%, and the purity of the phospholipid is too low to match the purity of the liquid crystalline phospholipid, further confirming that the liquid crystalline state described in this literature is questionable.

Chinese patent CN102517148A discloses a two-step decolorization method of phospholipids, which includes hydrogen peroxide bleaching and silica gel adsorption. The disadvantages of this method are as follows. (1) Chemical bleaching and decolorization causes the phospholipids to produce oxidated by-products and destroys the natural structure of phospholipids, which does not meet the criteria of green chemistry. (2) The efficiency of silica gel adsorption and decolorization is low, and the used silica gel becomes waste residue and is likely to cause environmental hazard. (3) Bleaching destroys the anti-oxidative structure in phospholipids, reduces the antioxidant properties and nutritional value of phospholipids, shortening the shelf life of phospholipids.

Although the phospholipid industry is currently developing rapidly, active phospholipid products, including all concentrated phospholipids and all acetone-extracted powdered phospholipids, still suffer from poor emulsification because of the limited purity of active phospholipid products.

The phospholipid processing aid of the present invention solves the technical problem of preparing active phospholipids, fills the gap in the industry, and fundamentally solves the problem of low emulsification of existing phospholipids.

### SUMMARY OF INVENTION

The object of the present invention is to provide a phospholipid processing aid and its application. The phospholipid processing aid is prepared by hydrolyzing the raw soybean oil sediments. At the same time, the aqueous solution of the phospholipid processing aid is used as the water phase to co-produce high-purity active phospholipid lamellar liquid crystals. It solves the technical difficulties encountered in preparing active phospholipid products, successfully offers active phospholipid products, and fundamentally solves the problem of poor surface activity of phospholipids products. The phospholipid processing aid and its preparation method and application have not been reported in the field of phospholipid processing or related research. The present invention is realized through the following technical solutions.

The present invention provides a phospholipid processing aid, which is a hydrolysate of impurity components in soybean oil sediments and is ionized in water.

Preferably, the phospholipid processing aid is a yellow-brown powdery solid that is easily soluble in water yet insoluble in n-hexane.

Preparation of an aqueous solution of the phospholipid processing aid is a necessary process for the formation of high-purity lamellar liquid crystals by combining active phospholipid components in soybean oil sediments with water, which is crucial to prepare active phospholipids lamellar liquid crystals. The process has following characteristics. Firstly, it should be technically necessary and indispensable to use phospholipid processing aid when active phospholipids and water aggregate to form lamellar liquid crystals. Secondly, the residual amount of the phospholipid processing aid should be reduced and should comply with related national standards by removal after the production process of active phospholipid lamellar liquid crystals. Thirdly, phospholipid processing aids should not be listed in the list of ingredients of the products.

The phospholipid processing aid is a yellow brown powdery solid that is easily dissolved and ionized in water. But it is insoluble in n-hexane. On the one hand, the hydrolysate is not native to soybean oil sediments, but is produced by hydrolysis. The reason is that the hydrolysate is n-hexane insoluble matter. The n-hexane insoluble content in soybean oil sediments is usually ≤0.3 g/100 g on a dry basis. The n-hexane insoluble content of the hydrolysate of the soybean oil sediments is normally 10-30 times to the n-hexane insoluble content of the raw soybean oil sediments. On the other hand, the hydrolysate is a new substance produced by the hydrolysis reaction of the impurity components in the raw soybean oil sediments. The reason is that no evidence of hydrolysis of oils and phospholipids in soybean oil sediments was found, such as an increase in lysophospholipids content and a decrease in phosphatidylcholine content, together with the inconsistency of characters between the hydrolysate of the impurity components in the raw soybean oil sediments and hydrolysates of oils and phospholipids.

Phospholipids with surface activity are abbreviated as active phospholipids. Active phospholipids can form lamellar liquid crystals and exhibit good emulsification and stability in water. We can detect the surface activity of phospholipids based on this. There are two main uses of the active phospholipids. One is surface-active use, where active phospholipids is mostly used as an emulsifier. The other is functional use. Because phospholipids contain phosphatidylcholine, that is, PC, active phospholipids are mostly used as nutritional supplements.

Inactivated phospholipids, as opposed to active phospholipids, refer to phospholipids that have lost their surface activity. The main reason for the inactivation of phospholipids is that they combine with metal ions such as calcium, magnesium, and iron to form phospholipid metal salts, also known as non-hydrated phospholipids. Inactivated phospholipids cannot form liquid crystals and have no emulsification effect in water, so they are not surfactants. For phospholipid products, inactivated phospholipids are impurities. The color of inactivated phospholipids is darker. Separating the inactivated phospholipids can improve the color of phospholipid products. Currently commercially available phospholipids, including all concentrated phospholipids and powdered phospholipids, are mixtures of active phospholipids and inactivated phospholipids, and there are no active phospholipid products.

The surface activity refers to the ability of soybean phospholipids to reduce the surface tension of water. Soybean phospholipids is called a surface-active substance, or surfactant. Surface activity is one of the main uses of soybean phospholipids. For example, soybean phospholipids are used as an emulsifier in injectable nutritional solutions, and they are used in milk powder to enhance instant solubility for their good surface activity.

The liquid crystal refers to soybean phospholipid liquid crystal, that is fluid with an anisotropic and ordered molecular arrangement formed by soybean phospholipid in water. The lamellar liquid crystal refers to a bilayer formed by active phospholipids and water that are arranged in a layered manner. The long axes of the molecules are parallel to each other and perpendicular to the layer plane. The hydrophobic groups are inside the bilayer and the hydrophilic groups are on the surface of the bilayer. The general properties of lamellar liquid crystals formed by active phospholipids and water are shown in Table 1.

TABLE 1
General properties of lamellar liquid crystals formed
by active phospholipids and water

| Type of | | Optical | Polarized |
|---|---|---|---|
| liquid crystal | Appearance | properties | pattern |
| Lamellar | Medium viscosity, | Anisotropy | Cross pattern or |
| liquid crystal | flowable | | oil pattern |

Hydrophilicity is an important indicator for analyzing surface activity of the active phospholipids, because active phospholipids are surface-active substances that are both hydrophilic and lipophilic, while inactivated phospholipids are not hydrophilic.

To detect the hydrophilicity of the active phospholipid lamellar liquid crystal comprises adding 4 g of active phospholipid lamellar liquid crystal to 100 g of pure water, stirring it with a 900 rpm stirrer, mixing evenly, and then putting it in a 3500 rpm centrifuge. After centrifugal settling for 5 minutes, a stable emulsion with uniform texture is obtained without precipitation.

The present invention also relates to a preparation method of the above-mentioned phospholipid processing aid, comprising the soybean oil sediments reacting with raw water, settling to obtain a layered product wherein the second layer of product from bottom to top is an aqueous phase, and drying the aqueous phase to obtain the phospholipid processing aid.

The reaction includes two categories: chemical reaction and physicochemical change. Chemical reaction means that the impurity components in the soybean oil sediments react with water to hydrolyze and produce a new substance— hydrolysate. The hydrolysate dissolves in the raw water and ionizes to produce a water phase. The physicochemical change refers to the generation of a new phase— lamellar liquid crystal— after the active phospholipid component in the soybean oil sediments combines with water.

The water phase is dried to obtain a yellow-brown powdery soybean oil sediment hydrolysate, which is also regarded as phospholipid processing aid. The active phospholipid lamellar liquid crystal is dried to obtain granular or powdered active phospholipid.

Preferably, the temperature of the reaction is 60-95° C., where the soybean oil sediments react with the raw water.

Hydrolysates and active phospholipid liquid crystals are produced at 0° C. to 100° C. The higher the temperature, the higher the efficiency. Therefore, increasing temperature of the water shortens the reaction time. However, it is not conducive to the stability of active phospholipid liquid crystals in boiling water. Boiling water or evaporation of water also wastes energy. Therefore the temperature is preferably 60-95° C. When the temperature is above 60° C., it is a sterilization temperature, which can prevent the soybean oil sediments from deteriorating during the reaction. When the temperature is below 95° C., it can prevent the water from boiling.

Preferably, the reaction time is 3-12 hours, where the soybean oil sediments and the raw water.

Although active phospholipid liquid crystals can be obtained by settling within 30 minutes, the time is preferably 3-12 hours as we want to improve the yield of active phospholipid liquid crystals. If the reaction time is too short, it will affect the yield of active phospholipid liquid crystal. If the reaction time is too long, the equipment will be occupied unnecessarily for too long, affecting production efficiency and capacity, and increasing production costs.

Preferably, before the reaction, the soybean oil sediments are mixed with the raw water and dispersed into particles by stirring. During the reaction the reactants are not stirred.

Preferably, the weight ratio of the soybean oil sediments and the raw water is 1:2-5.

To ensure the existence of an independent aqueous phase after the steps of fully absorbing phospholipids in soybean oil sediments, the amount of the raw water is set to be 2-5 times the weight of the raw soybean oil sediments. The functions of the water phase include: firstly, the hydrolysate of the raw oil sediments is dissolved and retained in the water phase so that the water phase has appropriate conductivity. This is a necessary process condition for active phospholipids and water to aggregate to form liquid crystals. Secondly, sufficient water source was provided for active phospholipids to form liquid crystals to prevent water shortage. Thirdly, the water phase separates active phospholipid liquid crystals and inactivated phospholipids, in which the density of the water phase is higher than oils and inactivated phospholipids and lower than active phospholipid liquid crystals. When the amount of the raw water used in the reaction system is too low, the soybean oil sediments cannot react with water effectively, which affects the combination of active phospholipids and water to form liquid crystals. When the weight of the raw water used in the reaction system exceeds 5 times the weight of the raw oil sediments, it increases the cost of water, energy consumption and increases the volume of the equipment though it is beneficial to the reaction of the soybean oil sediments.

The phase refers to the part of the raw material or product system that has uniform components with the same physical properties. The phase is separated from other components, and has an interface. The aqueous phase is an aqueous solution of soybean oil sediment hydrolysate, and has an interface with the phase formed by other components in the soybean oil sediments, such as the high-purity liquid crystal phase formed by the accumulation of active phospholipid components and water.

Preferably, the raw water is pure water or an aqueous solution of the phospholipid processing aid, with a conductivity of 0-10 mS/cm.

The raw water and the water phase are different concepts. The raw water belongs to the raw material and the water phase belongs to the product. The indicators of the water phase determine whether active phospholipid lamellar liquid crystals can be obtained, while the indicators of the raw water are only used as the basis for ingredients.

Preferably, one part of the raw water is absorbed by the active phospholipids in the soybean oil sediments to become bound water of the active phospholipid lamellar liquid crystal, and the other part of the raw water becomes a water phase, where the water phase is an aqueous solution of the phospholipid processing aid. The conductivity of the aqueous phase is 2-12 mS/cm.

The conductivity of the water phase is higher than the conductivity of the raw water. The reason is that the hydrolysate of the raw soybean oil sediments is dissolved in the raw water to form the water phase, which increases the conductivity. It should be noted that the aqueous solution of soybean oil sediment hydrolysate is used as the water phase, and the conductivity is in the range of 2-12 mS/cm, which is a necessary process condition for the active phospholipid component in soybean oil sediments to aggregate with water to form high-purity liquid crystal. When the conductivity of the water phase is less than 2.00 mS/cm, the aggregation of the active phospholipid liquid crystal weakens, leading to the failure of separating and collecting the liquid crystal from the water phase, and thus leading to the failure of preparing active phospholipid liquid crystal. When the conductivity of the water phase exceeds 12.00 mS/cm, the formation of liquid crystals by active phospholipids will be inhibited, leading to a significant reduction in the yield of active phospholipids and failure in preparing active phospholipid liquid crystals.

Preferably, sodium hydroxide or potassium hydroxide is added to the soybean oil sediments or the raw water.

More preferably, the weight of sodium hydroxide or potassium hydroxide is 0.01-0.5% of the weight of the soybean oil sediments.

Adding a trace amount of sodium hydroxide or potassium hydroxide to the raw material will help break up the raw oil sediments into granular form in the raw water. In most cases, sodium hydroxide or potassium hydroxide is not added into raw soybean oil sediments. In rare cases, the raw oil sediments will be difficult to break into granular form in the raw water without adding sodium hydroxide or potassium hydroxide.

There are two methods of settling: natural settling and centrifugal settling.

Preferably, under natural settling conditions, the product system of the reaction in which the soybean oil sediments react with the raw water, is divided into three layers: the upper layer, the middle layer and the lower layer. The upper layer is oil and deactivated phospholipid. The middle layer is aqueous phase. The lower layer is active phospholipid lamellar liquid crystal.

Preferably, under centrifugal settling conditions, the product system of the reaction in which the soybean oil sediments react with the raw water, is divided into 4 layers. The first layer from the top is oil, the second layer is deactivated phospholipid, and the third layer is water phase. The bottom layer is active phospholipid lamellar liquid crystal.

More preferably, the separation factor of the centrifugal settling is 1000-4000 g.

Preferably, the preparation of the aqueous phase and the preparation of the lamellar liquid crystal are completed simultaneously.

The active phospholipid lamellar liquid crystal is composed of water, active phospholipids and grease, in which the water content is 70-80 g/100 g, and the dry acetone insoluble content is 92-96 g/100 g. Birefringence phenomenon of oil-like polarized texture is observed using a polarizing microscope, which is a unique phenomenon in lamellar crystal liquids.

The active phospholipid lamellar liquid crystal was analyzed by small-angle X-ray scattering (SAXS) technology. Scattering factor q of small-angle X-ray scattering is between 0.5-2 nm-1 with an obvious Bragg scattering peak When measured with a rotational rheometer, its storage modulus G′ has always been significantly greater than the loss modulus G″, which indicates that the elastic response dominates. Thus, it is determined to be a lamellar liquid crystal.

The present invention also relates to the application of the above-mentioned phospholipid processing aid or the phospholipid processing aid prepared by the above-mentioned preparation method in the preparation of active phospholipid lamellar liquid crystals or active phospholipids.

The active phospholipid lamellar liquid crystal is dried and pulverized to obtain yellow particles active phospholipid or powdered active phospholipid, and the n-hexane insoluble content of the active phospholipid is ≤0.3 g/100 g.

The method of preparing granular or powdered active phospholipids using active phospholipid lamellar liquid crystals usually requires two steps: concentration and drying. Concentration refers to dehydrating active phospholipid liquid crystals with a water content of 70-80 g/100 g to a water content of about 50 g/100 g. Drying is to concentrate the active phospholipid liquid crystal with a water content of about 50 g/100 g (note, it is still in the liquid crystal state at this time, and the sensory index is still brown-red transmission color) by stirring the concentrated active phospholipid with a stirrer to obtain the phospholipid elastomer with yellow reflective color. The phospholipid elastomer is then made into strips and dehydrated at two temperatures of 90° C. and 60° C. to obtain strip-shaped solid active phospholipids. Finally, crush the strip-shaped active phospholipid. If it passes through a 16-mesh sieve, you will get a yellow granular active phospholipid; if you pass it through a 40-mesh sieve, you will get a yellow powdery active phospholipid. The water content of granular or powdered active phospholipids is less than 2 g/100 g. and the products comply with the Chinese national standard “GB28401 Food Additive Phospholipids”.

The beneficial effects of the present invention include:
(1) The role of phospholipid processing aids and the conductivity range of their aqueous solutions were specified, providing specific means of monitoring and control for the industrial production of active phospholipids.
(2) The residual amount of the phospholipid processing aids in the phospholipids complies with the Chinese national standard “GB28401 Food Additive Phospholipids” regarding n-hexane insoluble matter, and complies with the Chinese national standard “GB2760 Food Additives”, in which the processing aids only play a role in processing and should be separated from the finished product before the end of processing.
(3) The preparation of phospholipid processing aids and the preparation of high-purity active phospholipid lamellar liquid crystals are completed simultaneously. This co-production technical scheme is beneficial to saving costs in industrial production.
(4) The purpose of phospholipid processing aids is to prepare active phospholipid products, which fills the gap in the current market that hardly have active phospholipid products and fundamentally solves the current problem of poor surface activity of phospholipid products.
(5) The hydrolysis conditions for preparing phospholipid processing aids are mild, and the components such as oil and phospholipids in soybean oil sediments are not hydrolyzed. It is a good processing aid for preparing high-purity active phospholipid lamellar liquid crystals.

### BRIEF DESCRIPTION OF DRAWINGS

FIG. 1 shows a schematic diagram of the natural settling process for preparing phospholipid processing aids and active phospholipid lamellar liquid crystals in Examples 1-6.
wherein: the raw material in a is raw soybean oil sediments and water; the raw material in b is granular oil sediments and water; c shows the reactant system during the reaction process; and d shows the product system at the end of the reaction. (1) refers to raw material water. (2) refers to raw material soybean oil sediments. (3) refers to the oil sediments in the reaction. (4) refers to the water phase in which the hydrolysate is dissolved. (5) refers to the active phospholipid lamellar liquid crystal. (6) refers to oils and inactivated phospholipids.

FIG. 2 shows active phospholipid lamellar liquid crystal of Example 1.
wherein a refers to polarization image at 25° C. and b refers to polarization image at 75° C.

FIG. 3 shows a small-angle X-ray scattering (SAXS) diagram of the active phospholipid lamellar liquid crystal of Example 1.
wherein a is the SAXS curve at 25° C. and b is the SAXS curve at 75° C.

FIG. 4 shows a scanning curve diagram of active phospholipid layered liquid crystal in Example 1, obtained with a rotational rheometer, wherein a is the frequency sweep curve at 25° C. and b is the frequency sweep curve at 75° C.

### DESCRIPTION OF EMBODIMENTS

The disclosure may be more completely understood in consideration of the following detailed description of various embodiments of the disclosure in connection with the accompanying drawings.

The experimental methods described in the following examples are conventional methods unless otherwise specified; the reagents and materials described can be obtained from commercial sources unless otherwise specified.

The transmittance of active phospholipid liquid crystal was measured using the V-5600 visible spectrophotometer of Shanghai Yuanxi Instrument Co., Ltd.

The polarizing microscopy was performed on XPF-800 polarizing microscope from Shanghai Tiansheng Instrument Co., Ltd., equipped with a CCD camera and a hot stage.

Small-angle X-ray scattering (SAXS) was performed on the Anton-paar SAX Sess mc² system (Austria).

Rheological measurements were performed on a RS6000 rotational rheometer (HAAKE, Germany).

The conductivity measurement was performed on a multi-parameter transmitter produced by Mettler-Toledo Instruments (Shanghai) Co., Ltd. Model: M300 Process 2-channel 1/2 DIN. The conductivity sensor model: InPro7100i/12/120/4435. Electrode conductivity measurement range: 0.02-500 mS/cm.

### Example 1

A phospholipid processing aid and its application shown in FIG. 1 include the following steps:
100 parts of soybean oil sediments were added to 200 parts of purified water. The conductivity of the purified water was 0.0 mS/cm. The mixture was stirred to disperse the soybean oil sediments in the purified water into particles, to form a reactant system with particulate soybean oil sediments as the disperse phase and water as the continuous phase. The temperature was 95° C. and the reaction time was 3 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Jiayue (Tianjin) Co., Ltd. The composition of the soybean oil sediments was as follows. Water content: 40.75 g/100 g. Dry acetone insoluble content: 62.01 g/100 g.

After the reaction was completed, the conductivity of the obtained aqueous phase was 6.88 mS/cm. The water phase was an aqueous solution of the phospholipid processing aid. The water phase was vacuum dried to obtain a yellow-brown powdery phospholipid processing aid. The yield of the phospholipid processing aid accounted for 2.73% of the weight of the soybean oil sediments.

The obtained active phospholipid lamellar liquid crystals showed a brown-red transmission color, its water content was 76.10 g/100 g, and its dry acetone insoluble content was 95.58 g/100 g. The active phospholipid lamellar liquid crystal was then concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow reflective strip of solid active phospholipid. Next, it was grinded in a knife grinder. The strip-shaped solid active phospholipid was crushed and passed through a 16-mesh sieve to obtain yellow granular active phospholipid. The water content of abovementioned yellow granular active phospholipid was 1.01 g/100 g. The n-hexane insoluble content was 0.08 g/100 g. The dry acetone insoluble content was 95.58 g/100 g. The yield of the granular active phospholipid accounted for 80.97% of the weight of the acetone insoluble matter in the soybean oil sediments.

### Example 2

A phospholipid processing aid and its application include the following steps:
100 parts of soybean oil sediments were added to 300 parts of purified water. The conductivity of the purified water was 0.0 mS/cm. The mixture was stirred to disperse the soybean oil sediments in the purified water into particles, to form a reactant system with particulate soybean oil sediments as the disperse phase and water as the continuous phase. The temperature was 80° C. and the reaction time was 6 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the reaction was completed, the conductivity of the obtained aqueous phase was 4.28 mS/cm. The water phase was an aqueous solution of the phospholipid processing aid. The water phase was vacuum dried to obtain a yellow-brown powdery phospholipid processing aid. The yield of the phospholipid processing aid accounted for 4.91% of the weight of the soybean oil sediments.

The obtained active phospholipid lamellar liquid crystals showed a brown-red transmission color, its water content was 77.23 g/100 g, and its dry acetone insoluble content was 94.63 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow strip of solid active phospholipid. Next, it was grinded in a knife grinder. The strip-shaped solid active phospholipid was crushed and passed through a 16-mesh sieve to obtain yellow reflective granular active phospholipid. The water content of abovementioned yellow granular active phospholipid was 1.23 g/100 g. The n-hexane insoluble content was 0.06 g/100 g. The dry acetone insoluble content was 94.63 g/100 g. The yield of the granular active phospholipid accounted for 80.12% of the weight of the acetone insoluble matter in the soybean oil sediments.

### Example 3

A phospholipid processing aid and its application include the following steps:
100 parts of soybean oil sediments were added to 500 parts of purified water. The conductivity of the purified water was 0.0 mS/cm. The mixture was stirred to disperse the soybean oil sediments in the purified water into particles, to form a reactant system with particulate soybean oil sediments as the disperse phase and water as the continuous phase. The temperature was 60° C. and the reaction time was 12 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the reaction was completed, the conductivity of the obtained aqueous phase was 2.17 mS/cm. The water phase was an aqueous solution of the phospholipid processing aid. The water phase was vacuum dried to obtain a yellow-brown powdery phospholipid processing aid. The yield of the phospholipid processing aid accounted for 4.93% of the weight of the soybean oil sediments.

The obtained active phospholipid lamellar liquid crystals showed a brown-red transmission color, its water content was 78.65 g/100 g, and its dry acetone insoluble content was 93.97 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow strip of solid active phospholipid. Next, it was grinded in a knife grinder. The strip-shaped solid active phospholipid was crushed and passed through a 16-mesh sieve to obtain yellow reflective granular active phospholipid. The water content of abovementioned yellow granular active phospholipid was 1.18 g/100 g. The n-hexane insoluble content was 0.05 g/100 g. The dry acetone insoluble content was 93.97 g/100 g. The yield of the granular active phospholipid accounted for 80.20% of the weight of the acetone insoluble matter in the soybean oil sediments.

### Example 4

A phospholipid processing aid and its application include the following steps:
15 parts of the phospholipid processing aid obtained in Example 3 and 0.32 parts of sodium hydroxide were added to 300 parts of purified water to obtain raw water with the conductivity reaching 9.90 mS/cm. Then 100 parts of the soybean oil sediments were added to the raw water. The mixture was stirred to disperse the soybean oil sediments in the purified water into particles, to form a reactant system with particulate soybean oil sediments as the disperse phase and water as the continuous phase. The temperature was 70° C. and the reaction time was 12 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the reaction was completed, the conductivity of the obtained aqueous phase was 11.97 mS/cm. The water phase was an aqueous solution of the phospholipid processing aid. The water phase was vacuum dried to obtain a yellow-brown powdery phospholipid processing aid. After deducting the added 12.57 parts of the phospholipid processing aid, the yield of the phospholipid processing aid accounted for 4.37% of the weight of the soybean oil sediments.

The obtained active phospholipid lamellar liquid crystals showed a brown-red transmission color, its water content was 70.72 g/100 g, and its dry acetone insoluble content was 92.18 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow strip of solid active phospholipid. Next, it was grinded in a knife grinder. The strip-shaped solid active phospholipid was crushed and passed through a 16-mesh sieve to obtain yellow reflective granular active phospholipid. The water content of abovementioned yellow granular active phospholipid was 1.16 g/100 g. The n-hexane insoluble content was 0.11 g/100 g. The dry acetone insoluble content was 92.18 g/100 g. The yield of the granular active phospholipid accounted for 80.68% of the weight of the acetone insoluble matter in the soybean oil sediments.

### Example 5

A phospholipid processing aid and its application include the following steps:
8 parts of the phospholipid processing aid obtained in Example 4 and 0.04 parts of sodium hydroxide were added to 400 parts of purified water to obtain raw water with the conductivity reaching 4.31 mS/cm. Then 100 parts of the soybean oil sediments were added to the raw water. The mixture was stirred to disperse the soybean oil sediments in the purified water into particles, to form a reactant system with particulate soybean oil sediments as the disperse phase and water as the continuous phase. The temperature was 85° C. and the reaction time was 9 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the reaction was completed, the conductivity of the obtained aqueous phase was 7.48 mS/cm. The water phase was an aqueous solution of the phospholipid processing aid. The water phase was vacuum dried to obtain a yellow-brown powdery phospholipid processing aid. After deducting the added 8.00 parts of the phospholipid processing aid, the yield of the phospholipid processing aid accounted for 4.85% of the weight of the soybean oil sediments.

The obtained active phospholipid lamellar liquid crystals showed a brown-red transmission color, its water content was 74.89 g/100 g, and its dry acetone insoluble content was 95.89 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow strip of solid active phospholipid. Next, it was grinded in a knife grinder. The strip-shaped solid active phospholipid was crushed and passed through a 16-mesh sieve to obtain yellow reflective granular active phospholipid. The water content of abovementioned yellow granular active phospholipid was 1.20 g/100 g. The n-hexane insoluble content was 0.09 g/100 g. The dry acetone insoluble content was 95.89 g/100 g. The yield of the granular active phospholipid accounted for 80.13% of the weight of the acetone insoluble matter in the soybean oil sediments.

### Example 6

A phospholipid processing aid and its application include the following steps:
4 parts of the phospholipid processing aid obtained in Example 4 were added to 400 parts of purified water to obtain raw water with the conductivity reaching 2.28 mS/cm. Then 100 parts of the soybean oil sediments were added to the raw water. The mixture was stirred to disperse the soybean oil sediments in the purified water into particles, to form a reactant system with particulate soybean oil sediments as the disperse phase and water as the continuous phase. The temperature was 85° C. and the reaction time was 6 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Jiayue (Tianjin) Co., Ltd. The composition of the soybean oil sediments was as follows. Water content: 40.75 g/100 g. Dry acetone insoluble content: 62.01 g/100 g.

After the reaction was completed, the conductivity of the obtained aqueous phase was 5.64 mS/cm. The water phase was an aqueous solution of the phospholipid processing aid. The water phase was vacuum dried to obtain a yellow-brown powdery phospholipid processing aid. After deducting the added 4 parts of the phospholipid processing aid, the yield of the phospholipid processing aid accounted for 4.90% of the weight of the soybean oil sediments.

The obtained active phospholipid lamellar liquid crystals showed a brown-red transmission color, its water content was 75.01 g/100 g, and its dry acetone insoluble content was 93.63 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow strip of solid active phospholipid. Next, it was grinded in a knife grinder. The strip-shaped solid active phospholipid was crushed and passed through a 16-mesh sieve to obtain yellow reflective granular active phospholipid. The water content of abovementioned yellow granular active phospholipid was 1.21 g/100 g. The n-hexane insoluble content was 0.05 g/100 g. The dry acetone insoluble content was 93.63 g/100 g. The yield of the granular active phospholipid accounted for 80.09% of the weight of the acetone insoluble matter in the soybean oil sediments.

### Example 7

A surface activity test of the active phospholipid lamellar liquid crystal and the granular active phospholipid prepared therefrom. The following steps are included.

4 g of the active phospholipid lamellar liquid crystal sample obtained in Example 1 was added to 100 g of purified water at room temperature and stirred with a 900 rpm stirrer. After the active phospholipid lamellar liquid crystal was completely dispersed, it was put into a centrifuge tube and centrifuged at 3500 rpm for 5 minutes. After centrifugal settling, it became an emulsion with a uniform texture and no precipitates, that is, there was no floating matter on the surface, no suspended matter in the water, and no sedimentation at the bottom. Therefore, the surface activity of the sample was determined to be qualified.

1 g of the granular active phospholipid sample obtained in Example 1 (the average water content of the lamellar liquid crystal was 75%, so it was equivalent to 4 g of active phospholipid lamellar liquid crystal), was added to 100 g of purified water at room temperature, and stirred with a 900 rpm stirrer. After all the granular active phospholipids were dispersed, it was put into a centrifuge tube and centrifuged at 3500 rpm for 5 minutes. After centrifugal settling, it was an emulsion with a uniform texture and no precipitates, that is, there was no floating matter on the surface, no suspended matter in the water, and no matter at the bottom. Therefore, the surface activity of the sample was determined to be qualified.

### Example 8

A phospholipid processing aid and its application include the following steps:
100 parts of soybean oil sediments were added to 400 parts of purified water. The conductivity of the purified water was 0.0 mS/cm. The mixture was stirred to disperse the soybean oil sediments in the purified water into particles, to form a reactant system with particulate soybean oil sediments as the disperse phase and water as the continuous phase. The temperature was 60° C. and the reaction time was 3 h. At the end of the reaction, the product system was centrifuged for 5 min with a separation factor of 1000 g, where g stands for the Acceleration of Gravity. After centrifugal settling, the product system was divided into four layers: the first layer from the top was oil, the second layer was inactivated phospholipids, the third layer was aqueous phase, and the bottom layer was active phospholipid lamellar liquid crystal.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the centrifugal settling was completed, the conductivity of the obtained aqueous phase was 3.36 mS/cm. The water phase was an aqueous solution of the phospholipid processing aid. The water phase was vacuum dried to obtain a yellow-brown powdery phospholipid processing aid. The yield of the phospholipid processing aid accounted for 4.95% of the weight of the soybean oil sediments.

The obtained active phospholipid lamellar liquid crystals showed a brown-red transmission color, its water content was 75.13 g/100 g, and its dry acetone insoluble content was 94.35 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow reflective strip of solid active phospholipid. Next, it was grinded in a knife grinder. The strip-shaped solid active phospholipid was crushed and passed through a 16-mesh sieve to obtain yellow granular active phospholipid. The water content of abovementioned yellow granular active phospholipid was 1.16 g/100 g. The n-hexane insoluble content was 0.09 g/100 g. The dry acetone insoluble content was 94.35 g/100 g. The yield of the granular active phospholipid accounted for 80.81% of the weight of the acetone insoluble matter in the soybean oil sediments.

### Example 9

A phospholipid processing aid and its application include the following steps:
12 parts of the phospholipid processing aid obtained in Example 5 and 0.28 parts of sodium hydroxide were added to 300 parts of purified water to obtain raw water with the conductivity reaching 8.90 mS/cm. Then 100 parts of the soybean oil sediments were added to the raw water. The mixture was stirred to disperse the soybean oil sediments in the purified water into particles, to form a reactant system with particulate soybean oil sediments as the disperse phase and water as the continuous phase. The temperature was 95° C. and the reaction time was 3 h. At the end of the reaction, the product system was centrifuged for 5 min with a separation factor of 4000 g, where g stands for the Acceleration of Gravity. After centrifugal settling, the product system was divided into four layers: the first layer from the top was oil, the second layer was inactivated phospholipids, the third layer was aqueous phase, and the bottom layer was active phospholipid lamellar liquid crystal.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the centrifugal settling was completed, the conductivity of the obtained aqueous phase was 11.02 mS/cm. The water phase was vacuum dried to obtain a yellow-brown powdery phospholipid processing aid. After deducting the added 12 parts of the phospholipid processing aid, the yield of the phospholipid processing aid accounted for 4.41% of the weight of the soybean oil sediments.

The obtained active phospholipid lamellar liquid crystals showed a brown-red transmission color, its water content was 71.28 g/100 g, and its dry acetone insoluble content was 92.46 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow reflective strip of solid active phospholipid. Next, it was grinded in a knife grinder. The strip-shaped solid active phospholipid was crushed and passed through a 16-mesh sieve to obtain yellow granular active phospholipid. The water content of abovementioned yellow granular active phospholipid was 1.20 g/100 g. The n-hexane insoluble content was 0.10 g/100 g. The dry acetone insoluble content was 92.46 g/100 g. The yield of the granular active phospholipid accounted for 80.79% of the weight of the acetone insoluble matter in the soybean oil sediments.

### Comparative Example 1

A phospholipid processing aid and its application, including the following steps:
100 parts of soybean oil sediments were added to 600 parts of purified water. The conductivity of the purified water was 0.0 mS/cm. The mixture was stirred to disperse the soybean oil sediments in the purified water into particles, to form a reactant system with particulate soybean oil sediments as the disperse phase and water as the continuous phase. The temperature was 60° C. and the reaction time was 12 h. At the end of the reaction, it was naturally settled. The product system was divided into two layers: the upper layer and the bottom layer. The upper layer contained oil and deactivated phospholipids. The bottom layer contained aqueous phase and active phospholipid lamellar liquid crystal. In the bottom layer, brown transmission-colored phospholipid lamellar liquid crystal which was dispersed in the water phase was observed. The liquid crystal was difficult to aggregate and cannot be separated from the water phase.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

At the end of the reaction, the conductivity of the aqueous phase was detected to be 1.49 mS/cm.

Compared with Example 3, it showed that when the conductivity of the water phase was less than 2.00 mS/cm, the aggregation of the active phospholipid liquid crystal was weakened, making it difficult to separate the water phase and the active phospholipid lamellar liquid crystal, leading to the failure of the preparation of phospholipid processing aids and active phospholipids.

### Comparative Example 2

A phospholipid processing aid and its application include the following steps:
17 parts of the phospholipid processing aid obtained in Example 3 and 0.32 parts of sodium hydroxide were added to 300 parts of purified water to obtain raw water with the conductivity reaching 11.01 mS/cm. Then 100 parts of the soybean oil sediments were added to the raw water. The mixture was stirred to disperse the soybean oil sediments in the purified water into particles, to form a reactant system with particulate soybean oil sediments as the disperse phase and water as the continuous phase. The temperature was 70° C. and the reaction time was 12 h. At the end of the reaction, it was naturally settled. The product system was divided into three layers: the upper layer, the middle layer and the lower layer. The upper layer contained oil and deactivated phospholipids; the middle layer contained aqueous phase; and the lower layer contained active phospholipid lamellar liquid crystals.

Soybean oil sediments were bought from COFCO Cereals and Oils Industry (Jiujiang) Co., Ltd. The composition of the soybean oil sediments was as follows. Water content: 38.93 g/100 g. Dry acetone insoluble content: 61.34 g/100 g.

After the reaction was completed, the conductivity of the obtained aqueous phase was 12.98 mS/cm. The water phase was an aqueous solution of the phospholipid processing aid. The water phase was vacuum dried to obtain a yellow-brown powdery phospholipid processing aid. The yield of the phospholipid processing aid accounted for 4.26% of the weight of the soybean oil sediments.

The obtained active phospholipid lamellar liquid crystals showed a brown-red transmission color, its water content was 70.05 g/100 g, and its dry acetone insoluble content was 92.09 g/100 g. The active phospholipid lamellar liquid crystal was concentrated and dehydrated in a 95° C. vacuum rotary dryer to obtain a concentrated active phospholipid with a water content of 50 g/100 g. The concentrated active phospholipid was stirred with a 900 rpm stirrer to obtain an elastomer of yellow reflective active phospholipid. Then the elastomer was made into strips with a diameter of 3 mm, dried in a vacuum drying oven at 90° C. for 20 minutes, and then dried at 60° C. for 60 minutes to obtain a yellow strip of solid active phospholipid. Next, it was grinded in a knife grinder. The strip-shaped solid active phospholipid was crushed and passed through a 16-mesh sieve to obtain yellow reflective granular active phospholipid. The water content of abovementioned yellow granular active phospholipid was 1.30 g/100 g. The n-hexane insoluble content was 0.21 g/100 g. The dry acetone insoluble content was 92.09 g/100 g. The yield of the granular active phospholipid accounted for 16.78% of the weight of the acetone insoluble matter in the soybean oil sediments.

Compared with Example 4, when the conductivity of the aqueous phase exceeded 12.00 mS/cm, the formation of liquid crystals by active phospholipids was inhibited, leading to a significant reduction in the yield of active phospholipids and the failure of the co-preparation of phospholipid processing aids and active phospholipid lamellar liquid crystals.

### Comparative Example 3

A test of surface activity of powdered phospholipid by acetone extraction method, including the following steps:

the acetone extraction method of preparing powdered phospholipid comes from China patent CN103665029A.

(1) Soybean oil sediments and anhydrous acetone were mixed at a weight ratio of 1:10, stirred and extracted at normal pressure and room temperature for 20 minutes. Then it was centrifuged and settled for solid-liquid separation. The centrifugation time was 1 minute and the centrifugation speed was 4000 rpm, and the solid part was collected.

Soybean oil sediments were bought from COFCO Jiayue (Tianjin) Co., Ltd. The composition of the soybean oil sediments was as follows. Water content: 40.75 g/100 g. Dry acetone insoluble content: 62.01 g/100 g.

(2) The solid part obtained in step (1) was mixed with anhydrous acetone in a weight ratio of 1:10, stirred and extracted at room temperature and pressure for 20 minutes. Then it was centrifuged and settled for solid-liquid separation. The centrifugation time was 1 minute and the centrifugation speed was 5000 rpm. The solid part was collected.

(3) The solid part obtained in step (2) was mixed with anhydrous acetone at a weight ratio of 1:10, stirred and extracted at room temperature and pressure for 20 minutes. Then it was centrifuged and settled for solid-liquid separation. The centrifugation time was 1 min, the centrifugation speed was 5000 rpm, and the solid part was collected, crushed and dried under vacuum at 60° C. for 5 hours to obtain soybean powder phospholipid. The dry acetone insoluble content was 97.69 g/100 g, and the drying loss was 0.47 g/100 g.

1 g of the powdered phospholipid prepared by acetone extraction method was added to 100 g of purified water at room temperature, and stirred with a 900 rpm stirrer. After the phospholipid sample was completely dispersed, put it into a centrifuge tube and settled with the centrifugation speed of 3500 rpm for 5 minutes. After centrifugal settling, multiple precipitates were found, including a small amount of suspended matter in the water and a large amount of sedimentation at the bottom. Therefore, the surface activity of the sample was judged to be unqualified.

Same soybean oil sediments were used in both Example 7 and Comparative example 3, but the surface activity of the powdered phospholipids extracted by acetone was unqualified, which illustrated that the powdered phospholipids prepared in Comparative example 3 were a mixture of active and inactivated phospholipids with poor surface activity.

### Comparative Example 4

A surface activity test of transparent concentrated phospholipids including the following steps:
1 g of the transparent concentrated phospholipid provided by Shanghai Taiwei Pharmaceutical Co., Ltd. was added to 100 g of purified water at room temperature and stirred with a 900 rpm stirrer. After the phospholipid sample was completely dispersed, it was placed in a centrifuge tube and settled with the centrifugation speed of 3500 rpm for 5 minutes. After centrifugal settling, multiple precipitates were found, including a small amount of floating matter on the surface, a small amount of suspended matter in the water and a large amount of sedimentation at the bottom. Therefore, the surface activity of the sample was judged to be unqualified.

Comparison between Example 7 and Comparative Example 4 shows that the surface activity of the above-mentioned transparent concentrated phospholipid was unqualified, proving that the transparent concentrated phospholipid was a mixture of active phospholipid and inactivated phospholipid with poor surface activity.

### Test Example 1

In order to confirm the active phospholipid lamellar liquid crystal prepared in Example 1, following tests and characterization were carried out.

Light transmittance test: V-5600 visible spectrometer of Shanghai Yuanxi Instrument Co., Ltd. was used. The wavelength of detection was 450 nm. The samples were placed between two quartz plates with a thickness of 0.098 mm. Samples were allowed to stabilize for 10 minutes before testing.

Polarizing microscope image collection: An XPF-800 polarizing microscope (with CCD camera and hot stage) (Shanghai Tiansheng Instrument Co., Ltd.) at a magnification of ×25 were used to observe the birefringent polarizing texture of the sample. The sample was kept on the hot stage for 10 minutes before testing.

Small-angle X-ray scattering (SAXS) testing: Structural characterization of lamellar liquid crystal samples was performed on an Anton-paar SAX Sess mc2 system (Austria). The emission source was a Cu target, the wavelength was 0.154 nm, the operating voltage was 40 kV, and the current was 50 mA. The sample was placed in a stainless-steel groove and sealed with a film, and the temperature was controlled by computer using a Peltier heating system (Hecus MBraun, Graz, Austria). Each sample was allowed to stabilize in the instrument for 10 minutes before testing.

Rheology measurement: RS6000 rotational rheometer (Germany HAAKE Company) was used. The Z41Ti coaxial drum sensing system (the diameters of the drum and rotor are 43.40 mm and 41.42 mm respectively) was used as the measuring rotor. The sample was in the center of the sensing system and the thickness is 3 mm. Phoenix temperature control equipment was used to control the experimental temperature during the measurement process. Each sample was allowed to stand in the rotating drum for 10 minutes before the measurement was started, so that the structural damage during the sample addition process could be fully restored.

The brown-red transmission color was an obvious sensory characteristic of active phospholipid liquid crystals. A visible spectrophotometer was used to test the light transmittance of active phospholipid lamellar liquid crystals. The light transmittance was 70.2% at 25° C. and 70.4% at 75° C. The results showed that temperature had little effect on the transmittance of active phospholipid liquid crystals.

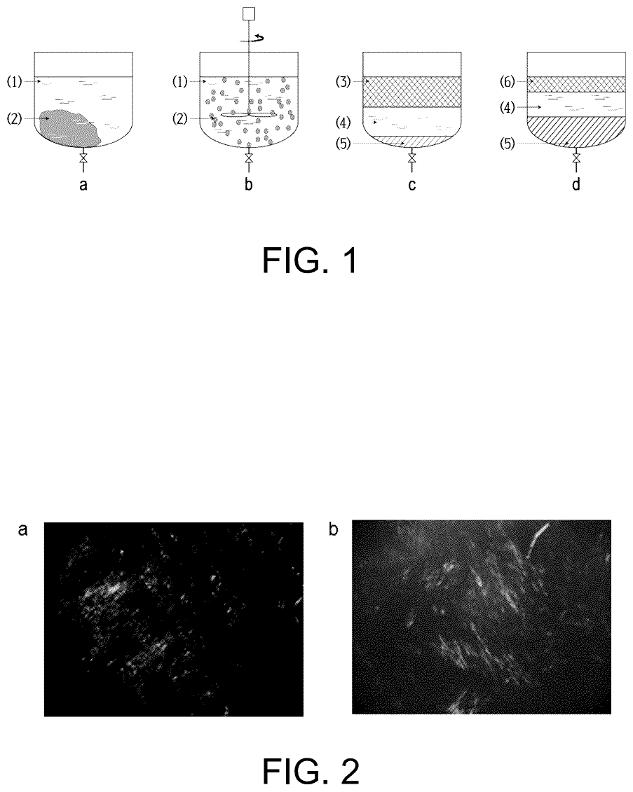

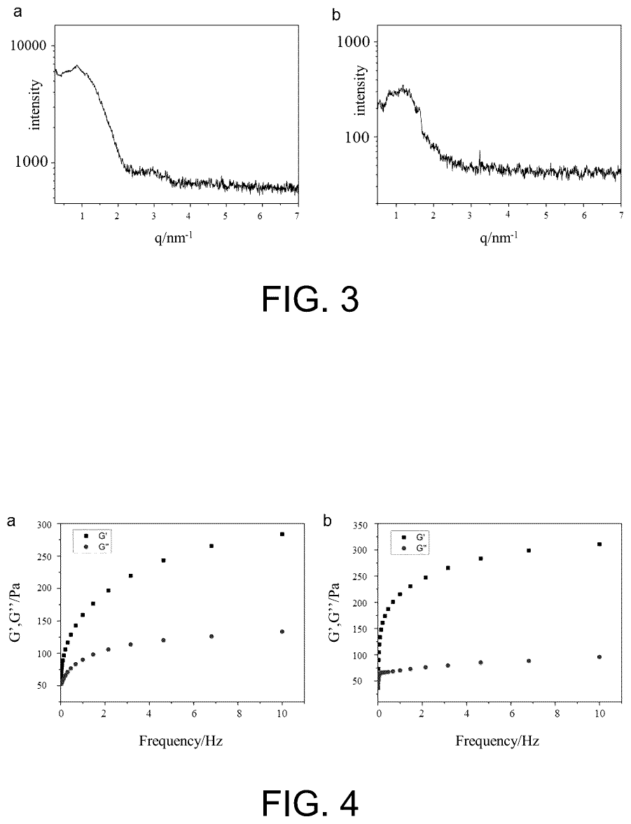

By using a polarizing microscope to observe the polarized texture of the active phospholipid liquid crystal sample, it was shown that there was an obvious oil-like polarized texture at a temperature of 25° C., which was a unique feature of lamellar liquid crystals (shown in a of FIG. 2). The feature of SAXS of the liquid crystal system was then characterized (shown in a of FIG. 3). A Bragg scattering peak was observed clearly when the scattering factor q was between 0.5-2 nm-1, which was unique to liquid crystals. In order to further explore the properties of the liquid crystal phase of this component, a rheological test was conducted, and a frequency scan was performed in the linear viscoelastic region. The experimental results were shown in a of FIG. 4. Within the measured frequency range, the storage modulus G′ of the sample had always been significantly larger than the loss modulus G″, indicating that the elasticity of the sample greatly exceeded the viscosity, and the elastic response dominated, further indicating the formation of lamellar liquid crystals.

When the detection temperature was increased to 75° C., the active phospholipid liquid crystal sample was subjected to polarizing microscopy and SAXS testing. Compared with the test results at 25° C., the birefringence phenomenon of the oil-like texture was still clear (shown in b of FIG. 2), and the Bragg scattering peak appearing in the SAXS spectrum was obvious (shown in b of FIG. 3). The above test results demonstrated that the sample of Example 1 was a lamellar liquid crystal, and the lamellar liquid crystal had good thermal stability. The sample was characterized by rheological technology at 75° C. Within the measurement frequency range, the storage modulus G′ of the sample was always greater than the loss modulus G″, and the elastic properties of the sample were outstanding (shown in b of FIG. 4). Therefore, it could be still regarded as a layered liquid crystal.

According to the abovementioned method, the liquid crystals obtained in Examples 2-6 and 8-9 were detected and found to be lamellar liquid crystals.

### Test Example 2

In order to confirm that the phospholipid processing aid is the hydrolysate of soybean oil sediments, the n-hexane insoluble matter in the phospholipid processing aids of Example 1 and Example 2, together with the raw material soybean oil sediments, was tested and compared. The detection method of n-hexane insoluble matter complied with the Chinese national standard “GB28401 Food Additive Phospholipids”.

The n-hexane insoluble content of the yellow-brown powdery phospholipid processing aid obtained by hydrolysis in Example 1 was 95.68 g/100 g, and the yield accounted for 2.73% of the weight of soybean oil sediments.

The raw soybean oil sediments in Example 1 were tested and it was found that the content of n-hexane insoluble matter on a dry basis was 0.21 g/100 g.

The content of n-hexane insoluble matter based on the soybean oil sediments was 0.13 g/100 g.

It showed that the n-hexane insoluble matter obtained by hydrolysis in Example 1 was 20.09 times that of the raw oil sediments.

The n-hexane insoluble content of the yellow-brown powdery phospholipid processing aid obtained by hydrolysis in Example 2 was 96.13 g/100 g, and the yield accounted for 4.91% of the weight of soybean oil sediments.

The raw soybean oil sediments in Example 2 were tested and found that the content of n-hexane insoluble matter on a dry basis was 0.29 g/100 g. The n-hexane insoluble content based on soybean oil sediments was 0.18 g/100 g.

It showed that the n-hexane insoluble matter obtained by hydrolysis in Example 2 was 26.22 times that of the raw oil sediments.

From the analysis of the test results of Example 1 and Example 2, the prepared phospholipid processing aid was not a component of the raw soybean oil sediments, but a hydrolyzed product of the soybean oil sediments.

The above detailed description is a specific description of one of the possible embodiments of the invention. This embodiment is not intended to limit the patent scope of the invention. All equivalent implementations or changes that do not depart from the present invention should be included in the present invention.

1. A phospholipid processing aid, comprising the phospholipid processing aid is a hydrolysate of impurity components in soybean oil sediments and it is ionized in water.

2. The phospholipid processing aid according to claim 1, wherein the phospholipid processing aid is a yellow-brown powdery solid that is easily soluble in water yet insoluble in n-hexane.

3. A preparation method for the phospholipid processing aid according to claim 1, comprising: the soybean oil sediments reacting with raw water, settling to obtain a layered product wherein the second layer of product from bottom to top is an aqueous phase, and drying the aqueous phase to obtain the phospholipid processing aid.

4. The preparation method according to claim 3, wherein the weight ratio of the soybean oil sediments and the raw water is 1:2-5, the temperature of the reaction is 60-95° C., and the reaction time is 3-12 h; before the reaction, the soybean oil sediments are mixed with the raw water and dispersed into particles by stirring; during the reaction, the reactants are not stirred.

5. The preparation method according to claim 3, wherein the raw water is pure water or an aqueous solution of the phospholipid processing aid, and the conductivity is 0-10 mS/cm.

6. The preparation method according to claim 3, wherein one part of the raw water is absorbed by the active phospholipids in the soybean oil sediments to become bound water of the active phospholipid lamellar liquid crystal, and the other part of the raw water becomes a water phase, where the water phase is an aqueous solution of the phospholipid processing aid and conductivity of the aqueous phase is 2-12 mS/cm.

7. The preparation method according to claim 3, wherein sodium hydroxide or potassium hydroxide is added to the soybean oil sediments or the raw water; preferably, the weight of the sodium hydroxide or potassium hydroxide is 0.01%-0.5% of the weight of the soybean oil sediments.

8. The preparation method according to claim 3, wherein the settling is natural settling or centrifugal settling; preferably, the separation factor of the centrifugal settling is 1000-4000 g.

9. A process of preparation of active phospholipid lamellar liquid crystal or active phospholipids, using the phospholipid processing aid as claimed in claim 1.

10. The process according to claim 9, wherein the active phospholipid lamellar liquid crystal is composed of water, active phospholipids and grease, in which the water content is 70-80 g/100 g and the dry acetone insoluble content is 92-96 g/100 g; birefringence phenomenon of oil-like polarized texture is observed using a polarizing microscope; sensory index is brown-red transmission color; scattering factor q of small-angle X-ray scattering is between 0.5-2 nm-1 with an obvious Bragg scattering peak; storage modulus G′ is greater than loss modulus G″.

11. A process of preparation of active phospholipid lamellar liquid crystal or active phospholipids, using the phospholipid processing aid prepared by the preparation method as claimed in claim 3 in the preparation of active phospholipid lamellar liquid crystals or active phospholipids.

12. The process according to claim 11, wherein the active phospholipid lamellar liquid crystal is composed of water, active phospholipids and grease, in which the water content is 70-80 g/100 g and the dry acetone insoluble content is 92-96 g/100 g; birefringence phenomenon of oil-like polarized texture is observed using a polarizing microscope; sensory index is brown-red transmission color, scattering factor q of small-angle X-ray scattering is between 0.5-2 nm⁻¹ with an obvious Bragg scattering peak; storage modulus G′ is greater than loss modulus G″.
